(19) United States
(12) Patent Application Publication
(10) Pub. No.: US 2018/0078452 A1
(43) Pub. Date: Mar. 22, 2018

(54) SMART PILL BOX SYSTEM AND METHOD

(71) Applicant: NTT Innovation Institute, Inc., Palo Alto, CA (US)

(72) Inventors: Yasuyuki Kataoka, Palo Alto, CA (US); Ravi Srivatsav, Palo Alto, CA (US)

(21) Appl. No.: 15/707,883

(22) Filed: Sep. 18, 2017

Related U.S. Application Data
(60) Provisional application No. 62/396,593, filed on Sep. 19, 2016.

(51) Int. Cl. A61J 1/03; A61J 7/04; G06F 19/00

(52) U.S. Cl. CPC A61J 1/03; A61J 7/0409; H04Q 9/00; H04Q 2209/40; G06F 19/3418

(57) ABSTRACT

A smart box system and method are provided that detects the opening of the box using a wireless sensor internal to the box. The box may be used to store a medication or jewelry.

### PRIORITY CLAIMS/RELATED APPLICATIONS

This application claims priority under 35 USC 120 and benefit under 35 USC 119(e) to U.S. Provisional Patent Application Ser. No. 62/396,593, filed Sep. 19, 2016 and entitled “Smart Pill Box System and Method”, the entirety of which is incorporated herein by reference.

### FIELD

The disclosure relates generally to a system and method that uses a smart pill box.

### BACKGROUND

Technologies have existed that are pill boxes with other features. For example, RemoPill is a smart pill container (the details of which may be found at https://remocam.com/tag/ces2016/and https://www.youtube.com/watch?v=e6B77i6Mdkw that are incorporated herein by reference) that reminds patients to take their medication as well as monitors their adherence. RemoPill alerts consumers when it is time to take their medication and monitors if the correct dosage was taken. However, the RemoPill has a short battery life and is expensive, especially for emerging countries, due to the many circuits in the RemoPill product.

Another existing product is made by Tricella that is smart pill box that also reminds patients to take their medication (details of which may be found at https://macsources.com/tricella-introduces-smart-pillbox/, http://www.tricella.com/ and https://www.youtube.com/watch?v, KzJ3dHNNIUA that are incorporated herein by reference.) The Tricella smart pill box is believed to use Open Detection by BLE, but has an expensive price, especially for emerging countries, for a pill box.

Another existing product is called Memo Box that is a smart pill box that appears to use a hinge type sensor to detect taking of a pill (details of which may be found at https://www.kickstarter.com/projects/661527809/memo-box-smart-companion-for-your-pills-and-vitami and http://www.gizmag.com/memo-box-medication-reminder/34579/ that are incorporated herein by reference.) However, this pill box is relatively expensive for a pill box and requires a new battery every 3 months and would need 4 batteries over an entire year.

In summary, the existing pill boxes are expensive for a pill box and the price would not be affordable for people at emerging countries, where a large population is still using a smart phone. Furthermore, the existing pill boxes may have short battery life due to, for example, a signal device and physical sensors for weight or rotation detection that usually results in high battery consumption.

### BRIEF DESCRIPTION OF THE DRAWINGS

FIG. 1 illustrates a smart pill box;

FIG. 2 illustrates a system that incorporates the smart pill box;

FIG. 3 illustrates the smart pill box and computing device when the smart bill box is closed;

FIG. 4 illustrates the smart pill box and computing device when the smart bill box is open and being detected by the computing device;

FIG. 5 illustrates a method for tracking pill usage that may be performed using the system shown in FIG. 2; and

FIGS. 6-7 illustrate examples of a user interface of the system that incorporates the smart pill box.

### DETAILED DESCRIPTION OF ONE OR MORE EMBODIMENTS

The disclosure is particularly applicable to a smart pill box using a Bluetooth Low Energy (BLE) beacon, an aluminum shielded pill box and smartphone device and it is in this context that the disclosure will be described. It will be appreciated, however, that the device and method has greater utility, such as to containers that contain other products, etc., such as jewels, as well as using other sensor technologies and shielding technologies that are within the scope of the disclosure.

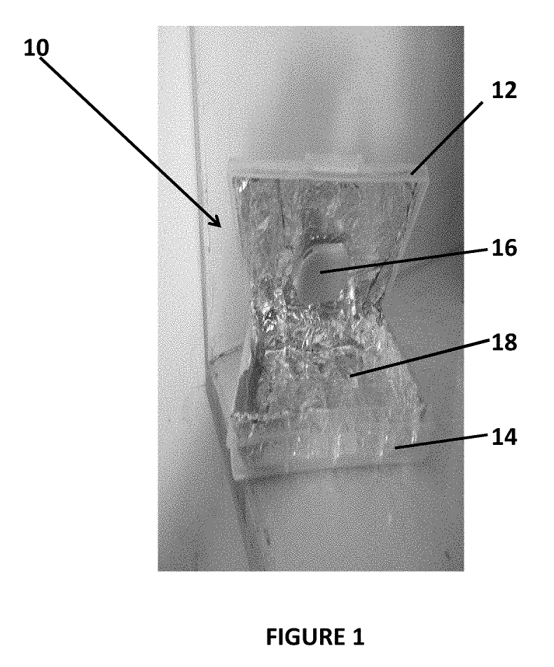

FIG. 1 illustrates a smart pill box 10 that may be used to store various products, pills, pharmaceutical products and any other product in which it is desirable to be able to track or monitor when the box is opened and/or closed by a user. For a box that contains pharmaceutical products, such as pills, the box is able to detect the opening or closing of the box by a user to track the user's taking of the pills/medication since medicine adherence is a highly recognized problem for pharmaceutical companies. The data about the detection of the opening of the box (and thus the user taking their prescribed medication) may be sent, via an application on a computing device, to a system that records that data in a medical record of the user. For a box that contains jewels or one or more pieces of jewelry, such as in a jewelry store, that box may be used to identify which employee opened what jewel box which is important for security issue in a jewelry store.

As shown in FIG. 1, the box 10 may have an upper portion 12 and a lower portion 14 that may connect to each other (in some manner) to close the box 10. While the box shown in FIG. 1 is square/rectangular shape, the box 10 may be various different shapes and the box is not limited to any particular shape or size. In some embodiments, the box 10 may have a clasp mechanism that securely attaches the upper portion 12 and the lower portion 14 to each other. The box 10 also may have a sensor 16 located inside the box that generates a wireless signal. In one embodiment, the sensor 16 may be a known Bluetooth Low Energy (BLE) sensor/beacon that may be commercially available and may or may not include a power source, such as a battery. In one embodiment, the sensor 16 may generate/emit a continuous wireless signal. The box 10 also may have a shield 18 that covers each inner surface of the upper portion 12 and each inner surface of the lower portion 14 in order to block the wireless signal from the sensor 16 when the box 10 is closed. In one embodiment, the shield 18 may be thin aluminum sheet that covers each inner surface of the box. In other embodiments, the shield 18 may be other known materials that coat the inner surface of the box and block the signal from the sensor 16.

The signal from the sensor 16 may be used to detect an opening of the box 10 by a computing device. The signal from the sensor 16 may be used to determine the closeness of a computing device to the box 10. Thus, the combination enables the detection of an opening of the box 10. In the embodiment that includes a BLE sensor 16 and an aluminum shield, the cost of the mechanism to detect the opening of the box is inexpensive and the mechanism to detect the opening of the box may operate for 1-2 years because this solution does not involve any other sensors.

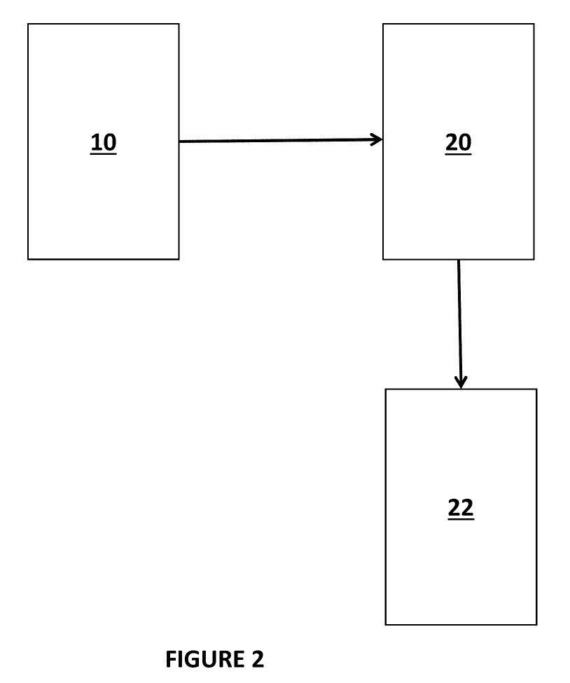

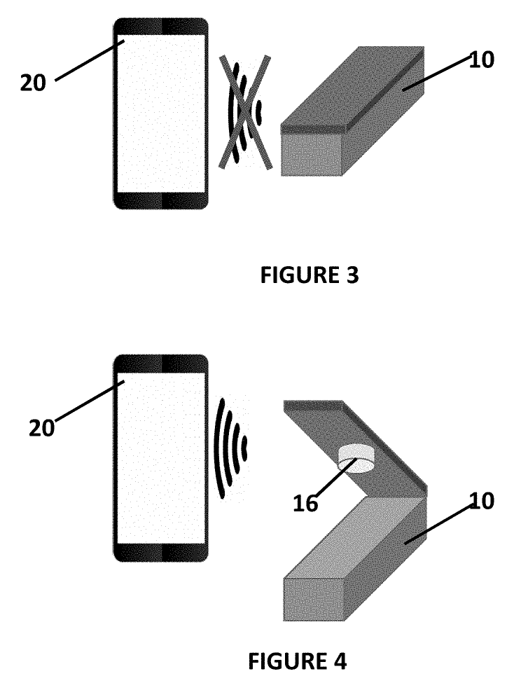

FIG. 2 illustrates a system that incorporates the smart pill box 10 for detecting box opening and prescription compliance of a user. The system may include a computing device 20 and a medical system 22 in which the computing device 20 is able to detect the wireless signal from the sensor 16 inside of the box when the box 10 is opened and the computing device 20 is able to communicate with the medical system 22 over a wired or wireless communication path. FIG. 3 illustrates the smart pill box 10 and computing device 20 when the smart bill box is closed and FIG. 4 illustrates the smart pill box 10 and computing device 20 when the smart bill box is open so that the sensor 16 is exposed and the signal from the sensor 16 may be detected by the computing device 20.

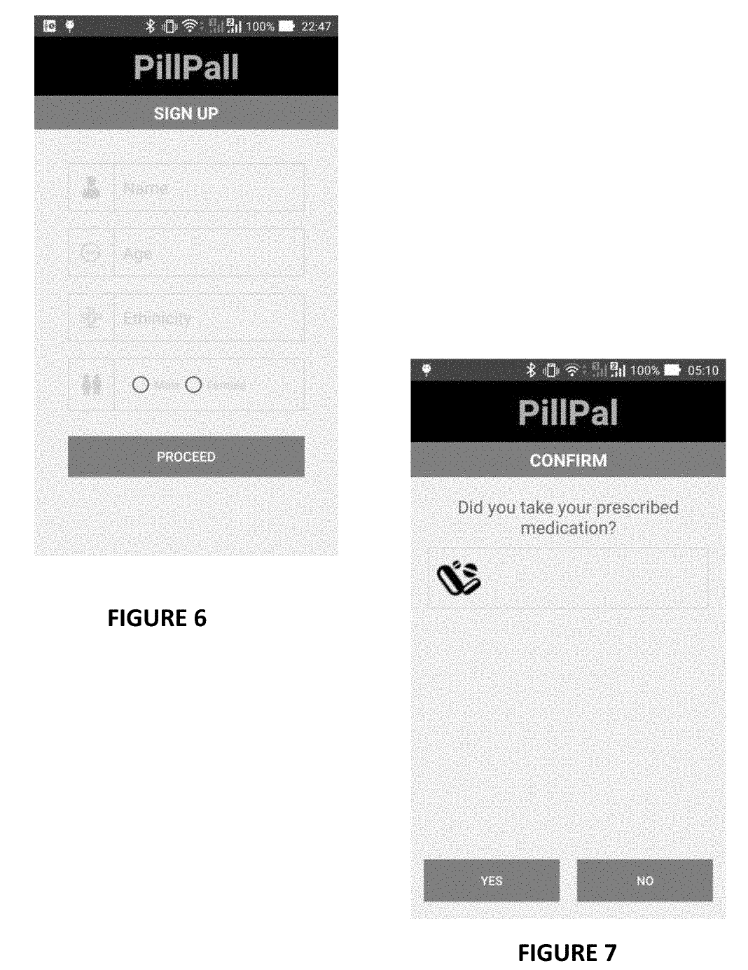

Returning to FIG. 2, the computing device 20 may be a processor based device with at least one processor, memory, persistent storage, such as flash memory or a hard disk drive, and sensing/communication capabilities (to wirelessly sense the sensor 16 when the box 10 is opened and communicate wirelessly or over a wired link with the medical system 22). In one embodiment, the sensing/communication capabilities may include a Bluetooth receiver/transceiver/chip when a BLE sensor is used and wireless communication chip that allow the computing device 20 to communicate with the medical system over a digital data cellular network. For example, the computing device may be a smartphone device, such as an Apple® iPhone® or Android® operating system based device, a personal computer, a tablet computer, a laptop computer and the like. The computing device 20 may further include an application/piece of software, such as a mobile application, an application resident on the device or an application downloaded to the device that may be executed by the processor of the computing device. The application may generate user interfaces for the user, examples of which are shown in FIGS. 6-7, may have functionality to receive the signal from the sensor 16 when the signal is detected, may generate data about the opening of the box by the user and send that data to the medical system 22.

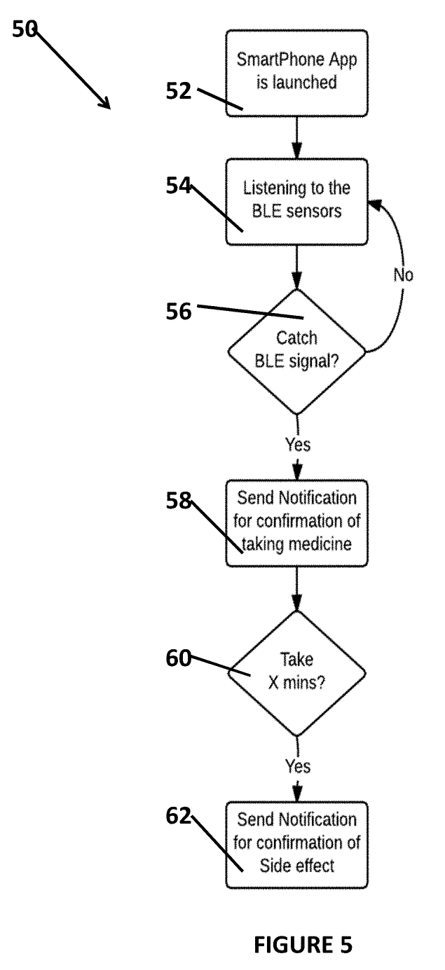

FIG. 5 illustrates a method 50 for tracking pill usage that may be performed using the system shown in FIG. 2. In the method, to track bill usage, the application on the computing device, such as a smartphone, may be launched (52) such as by using the exemplary login screen shown in FIG. 6. Prior to launching the application for the first time, the user may set up the application, called PillPal in the examples shown in FIGS. 6-7, by entering name, age, ethnicity, gender and other demographic information about the user. The application may run in the background, so that it can detect the sensor wireless signal.

Once the application is launched and active, it may listen for the sensor wireless signal (54), such as a BLE Bluetooth wireless signal when a BLE sensor is being used. As long as the sensor signal is not detected from the sensor inside of the box, the application will continue to listen for the sensor wireless signal (54). As long as the sensor signal is not detected, the box is closed since the sensor wireless signal is being blocked by the shield. When the sensor wireless signal is detected (indicating that the box has been opened), the method may generate and send a notification for a confirmation that the user took the medication (58) such as by using the using the exemplary user interface shown in FIG. 7. The method may then wait for a predetermined amount of time (60), such as 1-2 hours, after the user has confirmed that the user took the medication. Once the time period has lapsed, the method may generate a notification of whether the user has any side effects/adverse reaction to the medication (62) and ask the user to confirm whether they have had any side effects of the medication. The method may also generate data about the taking of the medication by the user and the side effects notification to the medical system 22.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A smart box, comprising:
a box that is closeable, the box having interior surfaces;
a wireless sensor inside of the box that emits a wireless signal;
a shield on each interior surface of the box, the shield blocking the wireless signal from the sensor from exiting the box when the box is closed; and
a computing device having a sensor that is capable of detecting the wireless signal from the sensor when the box is opened and confirming that a product is removed from the box once the box is opened.

2. The smart box of claim 1, wherein the sensor is a Bluetooth low energy sensor.

3. The smart box of claim 2, wherein the shield is aluminum.

4. The smart box of claim 1, wherein the product is one of a medication, a jewel and a piece of jewelry.

5. The smart box of claim 1, wherein the computing device further comprises a processor that executes an application that detects the wireless signal from the sensor when the box is opened and confirms that the product is removed from the box once the box is opened.

6. The smart box of claim 1, wherein the application confirms whether any side effects of the product occur.

7. A method for medication compliance, comprising:
providing a plurality of pills in a box, the box being closeable and having interior surfaces, a wireless sensor inside of the box that emits a Bluetooth low energy wireless signal and an aluminum sheet attached to each interior surface of the box that blocks the wireless signal from the sensor from exiting the box when the box is closed;
detecting the wireless signal from the sensor when the box is opened; and
confirming that a pill is removed from the box and taken by the user once the box is opened.

8. The method of claim 7 further comprising providing an application that detects the wireless signal from the sensor when the box is opened and confirms that the pill is removed from the box once the box is opened.

9. The method of claim 8 further comprising confirming, by the application, whether any side effects from taking the medication occurred.
